(19) United States
(12) Patent Application Publication
(10) Pub. No.: US 2011/0320475 A1
(43) Pub. Date: Dec. 29, 2011

(54) METHODS, APPARATUSES AND COMPUTER PROGRAM PRODUCTS FOR EXTENDING THE CAPABILITIES OF PLATFORM-INDEPENDENT APPLICATIONS ON DEVICES

(75) Inventor: Tochukwu Iwuchukwu, Mountain View, CA (US)

(73) Assignee: Nokia Corporation

(21) Appl. No.: 12/823,631

(22) Filed: Jun. 25, 2010

(51) Int. Cl. G06F 9/46; G06F 17/30

(52) U.S. Cl. 707/769; 719/328; 707/E17.014

(57) ABSTRACT

An apparatus for extending the functionalities of a platform-independent application(s) may include a processor and a memory storing executable computer code that cause the apparatus to at least perform operations including generating a request via a platform-independent application(s). The request comprises a query including information requesting a platform-dependent device to execute instructions. The computer program code may cause the apparatus to send the request to a network entity and receive a message from the network entity comprising data instructing the device to execute the instructions. The computer program code may also cause the apparatus to execute the instructions, via the device, in response to analyzing data of the message and provide results of the executed instructions to the network entity to enable sending of the results to the platform-independent application which may use the results to extend its functionalities. Corresponding computer program products and methods are also provided.

### TECHNOLOGICAL FIELD

Embodiments of the invention relate generally to functionalities of applications and, more particularly relate to a method, apparatus and computer program product for extending the services, operations and/or functionalities of platform-independent applications.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to utilizing software applications in smart communication devices.

For instance, many modern day smart communication devices provide software applications with the capability to deliver many useful services to users. One such example of a useful service provided by software applications relates to turn-by-turn route navigation applications that may use Global Positioning System (GPS) information from GPS-enabled mobile devices to provide real-time traffic updates or other location-based alerts as users travel along routes.

To interact with a smart communication device, an application may typically use an application programming interface (API) provided by the device. In many instances, the corresponding API specifications may be dependent on the device platform. For example, the API for one device platform may be in a different computer programming language from the API for another device platform. Additionally, two APIs in the same programming language may be drastically different. The consequence of the API being dependent on the device platform is that applications which interact with devices must typically be tailored to the specific platform on which they will run, that is, native variants of the application may have to be developed for different device platforms.

On the other hand, platform-independent applications such as web applications may run on virtually any device platform without modifications to the applications. Although web applications provide the benefit of platform-independence, they may lack the power of native applications.

The web execution environment may be limited in utilizing the power of smart communication devices. For instance, web programming languages may not support retrieving the GPS location of a mobile device. Even if a web programming language supported a given functionality, the web browser typically must also support that functionality.

Currently, web applications executing on smart communication devices may not be able to perform a wide range of useful operations such as reading or writing a file on the device, taking a picture with the device camera, launching another application on the device or powering down the device for power management.

To put it simply, web applications may not have the capability to perform many useful operations on today's smart communication devices due to the lack of support from the web execution environment. To combat this problem, application developers typically resort to developing native applications for the different device platforms. However, this approach typically involves allocation of various resources for the development of different versions of the native applications for execution on the different device platforms. Such allocation of resources may be costly and time consuming.

In view of the foregoing drawbacks, it may be beneficial to provide a mechanism that combines the uniformity of platform-independent applications such as, for example, web applications with the power of native applications to extend the capabilities of the platform-independent applications without requiring re-programming of the software of the platform-independent applications.

### BRIEF SUMMARY

A method, apparatus and computer program product are therefore provided that may extend the services, operations and/or functionalities of one or more platform-independent applications. The platform-independent applications may be cross-platform applications that are independent of any device platform (e.g., operating system). Additionally, the platform-independent applications of the exemplary embodiments may be any cross-platform applications that are restricted in performing certain operations on a communication device. The platform-independent applications may, but need not, be one or more web applications that may operate on any device platform.

The exemplary embodiments of the invention may enable a platform-independent application(s) to generate a request (e.g., network request) that includes information requesting a device or another application to carry out or execute instructions. In this regard, the request generated by the platform-independent application(s) may request the device/application to carry out or execute instructions on its behalf. The platform-independent application(s) and the device/application may, but need not, be embodied on the same communication device. The device/application may be dependent on a particular device platform. The request may be sent by the platform-independent application(s) to a network entity (e.g., server) which may generate a message that includes information instructing the device/application to carry out or execute the instructions requested by the platform-independent application(s).

In response to receipt of the message from the network entity, the device/application may carry out or execute the instructions specified in the message and may send the results of the executed instructions to the network entity. The network entity may generate another message that includes the results of the executed instructions and may send the results to the platform-independent application(s) which may use the data of the results to extend one or more of its functionalities or capabilities.

A platform-independent application that can extend its operations in the manner of the exemplary embodiments may result in drastic reduction in resources expended in time, manpower and money compared to the process of developing native variants of the same application for different platforms. Additionally, the application management process of the exemplary embodiment may facilitate easier handling of a platform-independent application. For example, software code bug fixes and updates may be more readily resolved for a platform-independent application by utilizing the exemplary embodiments of the invention.

Additionally, adding new features or services into a platform-independent application(s) according to the exemplary embodiments may be relatively easier compared to the conventional process of adding the same set of new features or services to the different native variants of the same application. By utilizing the exemplary embodiments, if a new feature is desired to be added to a platform-independent application, the platform-independent application may generate a request (e.g., network request) to a network entity with data for performing the relevant instructions that generate the new feature(s). In contrast, when adding new features to platform-dependent native applications as is done in the conventional approach, the new features may need to be added to each variant of the native applications that are designated for different target devices.

By utilizing the exemplary embodiments, a platform-independent application may automatically perform new types of operations on a smart communication device without requiring support from an execution environment such as for example a browser (e.g., web browser).

Additionally, by utilizing the exemplary embodiments the platform-independent applications may be upgraded transparently to a user of a communication device since the platform-independent applications may be accessed via a browser and a network address. This may not be the case for native application upgrades that may require re-downloading or re-installing software of the native application.

In one exemplary embodiment, a method for extending the functionalities of one or more platform-independent applications is provided. The method may include generating a request via at least one platform-independent application. The request may include a query including information requesting a platform-dependent device to execute instructions. The method may further include directing sending of the request to a network entity and receiving a message from the network entity including data instructing the device to execute the instructions. The method may also include executing the instructions, via the device, in response to analyzing the data of the message and facilitating provision of the results of the executed instructions to the network entity to enable sending of the results to the platform-independent application. The platform-independent application may use the results to extend its functionalities.

In another exemplary embodiment, an apparatus for extending the functionalities of one or more platform-independent applications is provided. The apparatus may include a processor and a memory including computer program code. The memory and computer program code are configured to, with the processor, cause the apparatus to at least perform operations including generating a request via at least one platform-independent application. The request may include a query including information requesting a platform-dependent device to execute instructions. The computer program code may further cause the apparatus to direct sending of the request to a network entity and receive a message from the network entity including data instructing the device to execute the instructions. The computer program code instructions may also facilitate execution of the instructions, via the device, in response to analyzing the data of the message and facilitate provision of the results of the executed instructions to the network entity to enable sending of the results to the platform-independent application. The platform-independent application may use the results to extend its functionalities.

In another exemplary embodiment, a computer program product for extending the functionalities of one or more platform-independent applications is provided. The computer program product includes at least one computer-readable storage medium having computer-executable program code instructions stored therein. The computer-executable program code instructions may include program code instructions configured to generate a request via at least one platform-independent application. The request may include a query including information requesting a platform-dependent device to execute instructions. The computer program product may also include program code instructions configured to direct sending of the request to a network entity and receive a message from the network entity including data instructing the device to execute the instructions. The computer program product may also include program code instructions configured to facilitate execution of the instructions, via the device, in response to analyzing the data of the message and facilitate provision of the results of the executed instructions to the network entity to enable sending of the results to the platform-independent application. The platform-independent application may use the results to extend its functionalities.

Embodiments of the invention facilitate efficient extension of services, operations and/or functionalities for platform-independent applications without requiring re-programming of the software of the platform-independent applications. The extension of the functionalities of the platform-independent applications may be transparent to the user of a communication device. As such, mobile terminal users may enjoy improved mobile device functionality.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of an apparatus according to an exemplary embodiment of the invention;

FIG. 3 is a schematic block diagram of a system for extending services, operations, functionalities and/or capabilities of platform-independent applications according to an exemplary embodiment of the invention;

FIG. 4 is a schematic block diagram of a network entity according to an exemplary embodiment of the invention;

FIGS. 5A-5D are diagrams illustrating formats of messages used by one or more platform-independent applications, a network entity and a native device/application according to an exemplary embodiment of the invention; and

FIG. 6 is a flowchart according to an exemplary method for extending the functionalities or capabilities of one or more platform-independent applications on a device according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

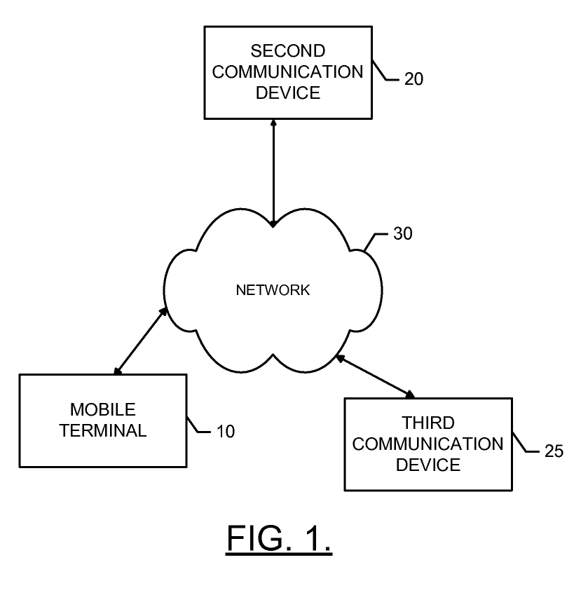

FIG. 1 illustrates a generic system diagram in which a device such as a mobile terminal 10 is shown in an exemplary communication environment. As shown in FIG. 1, an embodiment of a system in accordance with an example embodiment of the invention may include a first communication device (e.g., mobile terminal 10) and a second communication device 20 capable of communication with each other via a network 30. In some cases, embodiments of the invention may further include one or more additional communication devices, one of which is depicted in FIG. 1 as a third communication device 25. In some embodiments, not all systems that employ embodiments of the invention may comprise all the devices illustrated and/or described herein. While several embodiments of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ embodiments of the present invention. Furthermore, devices that are not mobile, such as servers and personal computers may also readily employ embodiments of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In some embodiments, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In example embodiments, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

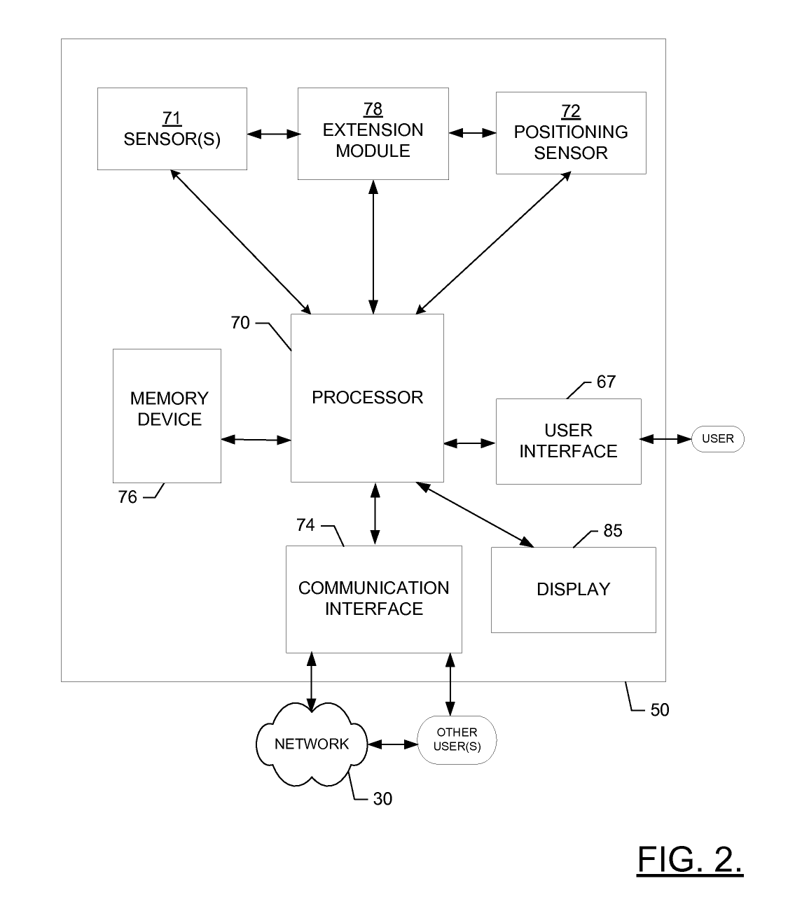

In an exemplary embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an exemplary embodiment, one or more of the devices in communication with the network 30 may employ an extension module (e.g., extension module 78 of FIG. 2). The extension module may execute or carry out instructions received from a network entity and may provide the results of the executed instructions to the network entity so that the network entity may send the results to a platform-independent application(s). The data of the results of the executed instructions sent by the network entity to the platform-independent application(s) may extend the services, operations, functionalities and/or capabilities of the platform-independent application(s).

In an exemplary embodiment, the mobile terminal 10 and the second and third communication devices 20 and 25 may be configured to include the extension module. However, in other alternative embodiments the mobile terminal 10 may include the extension module and the second and third communication devices 20 and 25 may be network entities such as servers or the like that are configured to communicate with the mobile terminal 10.

In an exemplary embodiment, the mobile terminal as well as the second and third communication devices 20 and 25 may employ an apparatus (e.g., apparatus of FIG. 2) capable of employing embodiments of the invention.

FIG. 2 illustrates a schematic block diagram of an apparatus for extending the services, operations and/or functionalities of one or more platform-independent applications according to an exemplary embodiment of the invention. An exemplary embodiment of the invention will now be described with reference to FIG. 2, in which certain elements of an apparatus 50 are displayed. The apparatus 50 may utilize any suitable platform (e.g., operating system (e.g., Symbian™, Android™, Windows Mobile™, etc.)) without departing from the spirit and scope of the invention. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in certain embodiments.

Referring now to FIG. 2, an apparatus for extending the services, operations and/or functionalities of one or more platform-independent applications is provided. The apparatus 50 may include or otherwise be in communication with a processor 70, a user interface 67, a communication interface 74, a memory device 76, a display 85, an extension module 78, a positioning sensor 72 and one or more sensor(s) 71. The memory device 76 may include, for example, volatile and/or non-volatile memory. The memory device 76 may be configured to store information, data, files, applications, instructions or the like for enabling the apparatus to carry out various functions in accordance with exemplary embodiments of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, videos, etc.). The memory device 76 may include one or more data repositories. In an exemplary embodiment, the memory device 76 may be a tangible memory device that is not transitory.

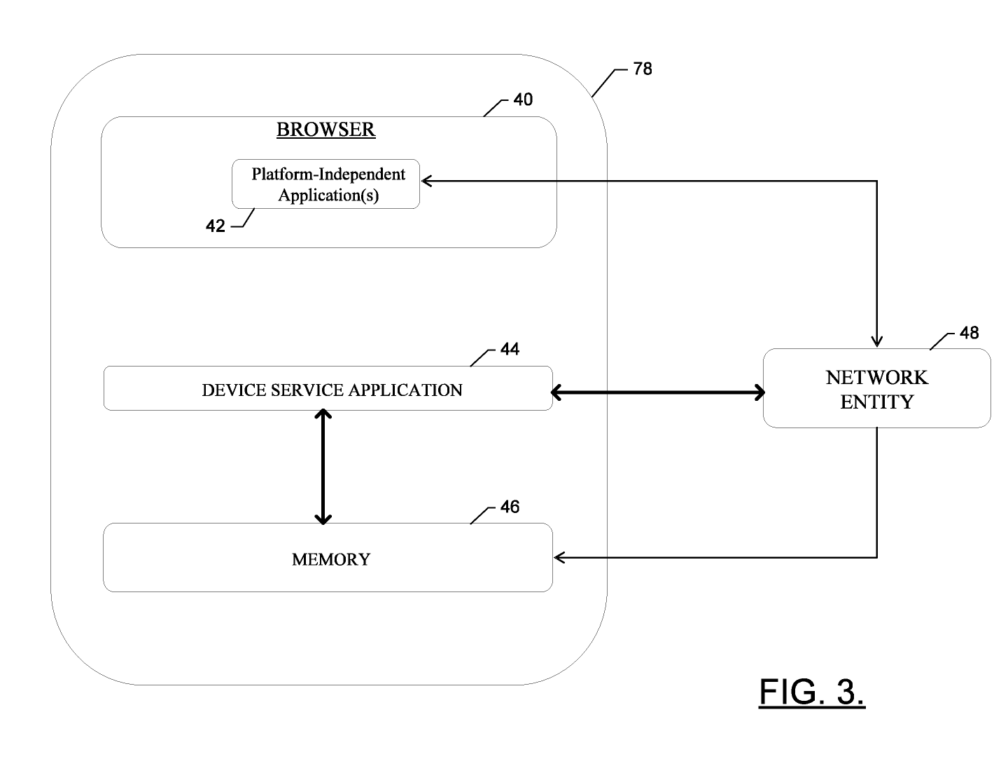

The data repositories may store messages such as for example, short message service (SMS) messages, multimedia messaging service (MMS) messages, electronic mail (email) messages or any other suitable messages. In this regard, memory 76 may include a SMS message inbox, a MMS message inbox, an email message inbox or any other suitable message inbox. The SMS message inbox, MMS message inbox, and/or email message inbox may receive messages from a network entity (e.g., network entity 48 of FIG. 3) instructing a device service application (DSA) (e.g., DSA 44 of FIG. 3) to carry out or execute instructions and to send the results of the instructions to the network entity so that the network entity may send the results to a platform-independent application (e.g., platform-independent application(s) 42 of FIG. 3) which requested information, as described more fully below.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to embodiments of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may otherwise be a general purpose processing element or other functionally configurable circuitry if not for the specific configuration provided by the instructions, to perform the algorithms and operations described herein. However, in some cases, the processor 70 may be a processor of a specific device (e.g., a mobile terminal) adapted for employing embodiments of the invention by further configuration of the processor 70 by instructions for performing the algorithms and operations described herein.

In an exemplary embodiment, the processor 70 may be configured to operate a connectivity program, such as a browser (e.g., browser 40 of FIG. 3), Web browser or the like. The browser may execute one or more platform-independent applications (e.g., platform-independent application(s) 42 of FIG. 3) such as for example web applications. In this regard, the connectivity program may enable the apparatus 50 to transmit and receive Web content, such as for example location-based content or any other suitable content, according to a Wireless Application Protocol (WAP), for example. The browser may utilize Hypertext Markup Language (HTML), JavaScript or any other suitable programming languages for handling Web content. The processor 70 may also be in communication with a display 85 and may instruct the display to illustrate any suitable information, data, content (e.g., media content) or the like.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an exemplary embodiment in which the apparatus is embodied as a server or some other network devices, the user interface 67 may be limited, remotely located, or eliminated.

The positioning sensor 72 may be in communication with processor 70 and the extension module 78. The positioning sensor 72 may include, for example, a global positioning system (GPS) sensor, an assisted global positioning system (Assisted-GPS) sensor, a Bluetooth (BT)-GPS mouse, or other GPS or positioning receivers or the like. In one embodiment, however, the positioning sensor may include a pedometer or inertial sensor. In another embodiment, the positioning sensor may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the positioning sensor as described below. Thus, in examples in which software is employed, a device or circuitry (e.g., processor 70 in one example) executing the software forms the structure associated with such means.

In this regard, for example, the positioning sensor 72 may be configured to generate, among other things, GPS data that may be used by the processor of the apparatus to determine the location of the apparatus. The data associated with the location may but need not include information related to one or more of longitude, latitude and altitude coordinates of the apparatus. In an exemplary embodiment, the extension module 78 may query the positioning sensor 72 for location information and upon receipt of the location information the extension module 78 may send the location information to a network entity such as, for example, a server that provides the location information to a platform-independent application(s) that requested the location information, as described more fully below.

The apparatus 50 may also include one or more sensors 71 (also referred to herein as sensor(s) 71). In an exemplary embodiment, the sensors 71 may, but need not, include a light sensor configured to detect light, an accelerometer configured to detect or measure acceleration, a compass configured to determine direction, a tilt sensor configured to measure the tilt in axes of a reference plane, and/or a moisture sensor configured to measure moisture and relative humidity.

The extension module 78 may query any of the one or more sensors 71 for information and the extension module 78 may send the information to a network entity such as for example a server that provides the information to a platform-independent application(s). For instance, the extension module 78 may query the compass for information related to the direction of the apparatus 50 and upon receipt of the direction information, the extension module 78 may provide the direction information to a network entity that sends the direction information to a platform-independent application that requested the direction information.

In an exemplary embodiment, the processor 70 may be embodied as, include or otherwise control the extension module 78. The extension module 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the extension module 78 as described below. Thus, in examples in which software is employed, a device or circuitry (e.g., the processor 70 in one example) executing the software forms the structure associated with such means. In this regard, for example, the extension module 78 may be configured to provide, among other things, for the extension of services, operations and/or functionalities of one or more platform-independent applications such as, for example, web applications as described more fully below.

Referring now to FIG. 3, an exemplary embodiment of an extension module 78 for extending the services, operations, functionalities and/or capabilities of one or more platform-independent applications is provided. The extension module 78 may include a browser 40, one or more platform-independent applications 42 (also referred to herein as platform-independent application(s) 42, or client(s) 42), a device service application (DSA) 44 (also referred to herein as device 44) and a memory 46. The DSA 44 may be a native application that is platform-dependent.

The browser 40 may, but need not, be a Web browser that is configured to access the World Wide Web (also referred to herein as Web), a user interface that facilitates navigation of objects which are not necessarily or entirely related to the Web, or any other suitable browser. The one or more platform-independent applications 42 may, but need not, be web applications.

As shown in FIG. 3, the extension module 78 may be in communication with a network entity 48 (e.g., second communication device 20 or third communication device 25) such as for example a server. It should be pointed out that the extension module 78 may be in communication with the network entity 48 via the communication interface 74 (and/or via processor 70). In this regard, the memory 46 may receive communications (e.g., one or more messages) from the network entity 48. The platform-independent application(s) 42, and the DSA 44 may also communicate with the network entity 48.

The memory 46 may include, for example, volatile and/or non-volatile memory. In an exemplary embodiment, the memory 46 may be a tangible memory device that is not transitory. The memory 46 may be configured to store information, data, applications, instructions or the like for enabling the extension module 78 to carry out various functions in accordance with the exemplary embodiments. Additionally, memory 46 may include one or more data repositories which may, but need not, include one or more of an SMS message inbox, MMS message inbox, email message inbox or any other suitable message inbox. As described above, at least one or more of the SMS message inbox, MMS message inbox, or email message inbox may, but need not, be stored in the memory device 76. The DSA 44 is capable of accessing information stored in SMS inbox, MMS message inbox, email message inbox or any other suitable inbox of the memory 46 and/or memory device 76 (e.g., via processor 70). It should be pointed out that at least a portion of the messages of the SMS message inbox, the MMS message inbox or the email message inbox may be received from the network entity 48. The SMS message inbox, MMS message inbox and/or email message inbox may receive one or more messages from the network entity 48 in response to receipt of a request for information, on the apparatus 50, from a platform-independent application 42.

The DSA 44 may be any device or means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the DSA 44, as described below. Thus, in examples in which software is employed, a device or circuitry (e.g., the processor 70 in one example) executing the software forms the structure associated with such means.

In this regard, for example, the DSA 44 may be configured to provide, among other things, for the retrieval of messages from one or more data repositories such as an inbox (e.g., SMS message inbox). The messages in the data repository such as the inbox (e.g., SMS inbox) may be provided by the network entity 48 in response to receipt of a request for information from a platform-independent application(s) 42 which requested information that may be on the apparatus 50. The DSA 44 may execute instructions specified in the retrieved messages and may send the results of the executed instructions to the network entity 48. The network entity 48 may then send the data of the results of the executed instructions to the platform-independent application(s) 42 that requested information. It should be pointed out that the DSA 44 may execute the instructions in the retrieved message by instructing another device (e.g., positioning sensor 72) to provide the DSA 44 with information (e.g., location information such as, for example, GPS coordinates) or to perform a function(s) (e.g., read a file) and then provide the information pertaining to the results of the performed function(s) to the DSA 44.

The platform-independent application(s) 42 may include software instructions, computer code or the like. In this regard, the platform-independent application(s) 42 may be one or more software applications that are hosted in a browser controlled environment. Additionally, the platform-independent applications may be any software applications that are not dependent on the platform (e.g., operating system) of the apparatus 50. In an exemplary embodiment, the platform-independent applications 42 may, but need not be web applications (also referred to herein as web clients) that may be hosted in a browser controlled environment and may be coded in any suitable programming languages that rely on a browser to execute the applications.

The network entity 48 may receive requests from one or more of the platform-independent applications 42. The requests received from the platform-independent applications 42 may be network requests (e.g., Hypertext Transfer Protocol (HTTP) requests, File Transfer Protocol (FTP) requests) and may include information requesting data that is on the apparatus 50 or accessible by one or more devices of the apparatus 50 in response to performing a function(s) (e.g., the positioning sensor 72 detecting location information). Additionally, the network entity 48 may provide messages containing at least a portion of the information received in the requests from a platform-independent application(s) 42 to one or more memories (e.g., memory 46 and/or memory device 76) of the apparatus 50.

As described above, the messages sent to the apparatus 50 by the network entity 48 may be stored in one or more data repositories which may include one or more message inboxes for storage of the messages. In an exemplary embodiment, the extension module 78 may designate a message inbox (e.g., SMS message inbox) for storage of the messages received from the network entity 48. The network entity 48 may also receive data from the DSA 44 in response to the DSA 44 executing instructions in messages provided to the extension module 78 (e.g., memory 46) or accessible via the extension module 78 (e.g., messages stored in memory device 76 that are accessible by extension module 78 via processor 70). The network entity 48 may send the data received from the DSA 44 to the corresponding platform-independent application(s) 42 that requested information from the apparatus 50. In this regard, the relevant platform-independent application 42 (e.g., web application) may utilize the information (e.g., location information) provided to the network entity 48 by the DSA 44 to extend its services, operations and/or functionalities.

For example, by using location information (e.g., GPS coordinates such as, for e.g., longitude, latitude and/or altitude coordinates) provided to the network entity 48 by the DSA 44, the platform-independent application 42 may provide the apparatus 50 with the location of one or more restaurants based on the location information. It should be pointed out that one or more of the platform-independent applications 42 may extend their functionalities or capabilities in any suitable manner on the basis of the information that the DSA 44 provides to the network entity 48 which is sent to the respective platform-independent applications 42. For instance, the platform-independent applications 42 may extend their functionalities or capabilities to read or write a file on the apparatus 50, take a picture(s) with a camera (not shown) on the apparatus 50, launch another application(s) on the apparatus 50, power down the apparatus 50 for power management, utilize sensor information or any other suitable function(s). The sensor information (e.g., location information, detected light information, tilt information, direction information, acceleration information, moisture information) may be based on information received by the DSA 44 from the positioning sensor 72, light sensor, tilt sensor, the compass, the accelerometer and the moisture sensor of the sensors 71.

An exemplary embodiment of the invention will now be described with reference to FIG. 3. For purposes of illustration and not of limitation, consider an example in which the positioning sensor 72 provides location information to the DSA 44 in response to the retrieval of a message by the DSA 44 from the network entity 48. In this regard, the network entity 48 may receive a request (e.g., network request (e.g., HTTP request)) from a platform-independent application 42 (e.g., web application) being executed on the apparatus 50. The platform-independent application may be executed by the browser 40 under the control of processor 70. The request may contain instructions to be carried out by the DSA 44. For example, the platform-independent application 42 may desire location information from the positioning sensor 72 and in this regard the platform-independent application 42 may send an HTTP request to the network entity 48 that includes information requesting the DSA 44 to query the positioning sensor 72 for location information.

The network entity 48 may receive and process the request from the web application 42 and may generate a message to send to the apparatus 50. The message received by the apparatus 50 may be stored in memory 46 of the extension module 78 or the memory device 76 and may be provided in a message inbox in the manner described above. For purposes of illustration and not of limitation, presume that the extension module 78 designated that the memory 46 store the messages received from the network entity 48 in a designated message inbox such as, for example, an SMS message inbox. It should be pointed out that the message received by the extension module 78 which may be stored in memory 46 may contain instructions for the DSA 44 to retrieve the requested location information from the positioning sensor 72 as well as the network or Internet Protocol (IP) address (also referred to herein as address) of the network entity 48. The address of the network entity 48 may be included in the message so that the DSA 44 may initiate future communications with the network entity 48 by using the address.

In response to retrieving the message sent by the network entity 48 to apparatus 50, the DSA 44 may analyze the instructions in the message and may carry out or execute the instructions. In this example, the DSA 44 may analyze the message and determine that data of the message relates to instructions for querying the positioning sensor 72 for location information (e.g., GPS coordinates such as, for e.g., latitude, longitude, altitude coordinates) of the apparatus 50. As such, the DSA 44 may query the positioning sensor 72 for the location information and in response the positioning sensor 72 may send the DSA 44 the corresponding location information of the apparatus 50. Upon receipt of the location information from the positioning sensor 72, the DSA 44 may provide the location information to the network entity 48 which may send the location information to the respective platform-independent application 42. The platform-independent application 42 may then utilize the received location information to extend its services, operations functionalities and/or capabilities. For instance, the platform-independent application 42 may utilize the location information to provide the apparatus 50 a list of entities (e.g., movie theaters) having locations corresponding to the location information.

As another example, consider a situation in which a platform-independent application 42 such as, for example, a web application desires to monitor a device sensor such as positioning sensor 72. In this regard, the web application or web client may desire to be notified every five seconds of the location of the apparatus 50. As such, the web client 42 may generate a request (also referred to herein as a position monitoring request) and may include data specifying that the position or location of the apparatus 50 be monitored every five seconds and the corresponding data provided to the web client 42. In this manner, the web client 42 may send the request to the network entity 48 and the network entity 48 may generate a message (also referred to herein as a position monitoring message) instructing the DSA 44 to monitor the positioning sensor 72 every five seconds and provide the corresponding position/location information to the network entity 48. As described above, the network entity 48 may include its network or IP address in the position monitoring message and may send this message to the apparatus 50 which may store the message in the SMS message inbox of memory 46, for example.

Upon retrieving the position monitoring message, the DSA 44 may analyze the data of the message and perform the instructions in the message. As such, the DSA 44 may query the positioning sensor 72 every five seconds for position/location information and may send the position/location information as it is received every five seconds to the network entity 48 by using the network or IP address in the position monitoring message. In response to the network entity 48 receiving the position/location information every five seconds, the network entity 48 may send this information to the requesting web client 42, which may utilize this information for any suitable purpose. For instance, the position/location information sent to the web client 42 by the network entity 48 every five seconds may be used by the web client 42 to extend its services, operations, functionalities and/or capabilities.

It should be pointed out that in the foregoing examples, that the DSA 44 and the network entity 48 may, but need not, maintain the original network connection (e.g., the original HTTP network connection) for future communication since the DSA 44 may utilize the address of the network entity 48 to send the network entity 48 information requested in the messages. In this regard, a platform-independent application 42 and the network entity 48 may communicate in an asynchronous manner by using the address of the network entity 48. By communicating in an asynchronous manner, a platform-independent application 42 and the network entity 48 are not required to keep a corresponding network connection open. Instead, the platform-independent application 42 may make a request (e.g., network request (e.g., HTTP request)) to open a connection with the network entity 48 and may include information in the request specifying that the DSA 44 is to execute instructions. Upon receipt of the request, the network entity 48 may close the connection with the platform-independent-application 42. When the network entity 48 receives the results of the executed instructions from the DSA 44, the network entity 48 may open another connection with the platform-independent application 42 and may send the results of the executed instructions to the platform-independent application 42. In the situation where the network entity 48 is unable to initiate a connection with the platform-independent application 42 (for example, when the platform-independent application 42 is executing on a communication device(s) that does not have assigned network addresses), the network entity 48 may store the results of the executed instructions for retrieval by the platform-independent application 42. In this manner, the platform-independent application 42 and the network entity 48 do not necessarily need to maintain the original network connection for future communication.

It should be pointed out that a benefit of the DSA 44 using the address of the network entity 48 to communicate with an application 42 is that such a scheme may be utilized to recover from network failures. Additionally, since communication may be initiated as needed, network resource waste may be kept at a minimum as opposed to situations in which a network connection (e.g., HTTP network connection) is kept open even when no relevant activity is occurring on the apparatus 50.

As described above, when the network entity 48 receives a response from the DSA 44, it may process the response and may send any relevant information to a respective platform-independent application. It should also be pointed out that if the initial platform-independent application-network entity connection has terminated or the platform-independent application-network entity communication is asynchronous, the network entity may store the information to enable the platform-independent application to issue new requests to retrieve information associated with previous requests. In this situation, when the network entity 48 receives a subsequent request from the platform-independent application, the network entity may analyze a request identifier (RID) in the stored information to determine if it matches the RID received in the subsequent request and if there is a match, the network entity may determine that the stored information is intended for a corresponding platform-independent application. As such, the network entity 48 may send the stored information to the corresponding platform-independent application when it receives the subsequent request from the platform-independent application.

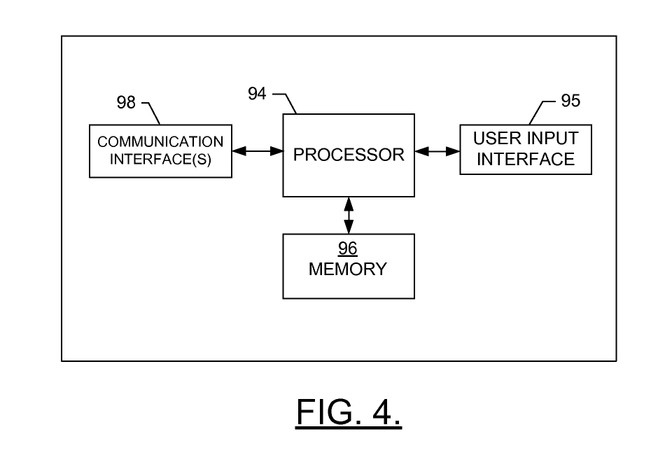

Referring now to FIG. 4, a block diagram of an exemplary embodiment of a network entity, such as, for example, network entity 48 of FIG. 3 is provided. As shown in FIG. 4, the network entity 48 (e.g., a server) generally includes a processor 94 and an associated memory 96. The memory 96 may comprise volatile and/or non-volatile memory, and may store content, data and/or the like. For example, the memory may store content, data, information, and/or the like transmitted from, and/or received by, the network entity. Also for example, the memory 96 may store client applications, instructions, and/or the like for the processor 94 to perform the various operations of the network entity in accordance with embodiments of the invention, as described above.

In addition to the memory 96, the processor 94 may also be connected to at least one interface or other means for displaying, transmitting and/or receiving data, content, and/or the like. In this regard, the interface(s) may comprise at least one communication interface 98 or other means for transmitting and/or receiving data, content, and/or the like, as well as at least one user input interface 95. The user input interface 95, in turn, may comprise any of a number of devices allowing the network entity to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

The network entity, for example network entity 48, may receive a request(s) from one or more platform-independent applications 42. The request(s) received from the platform-independent applications may include instructions for the DSA 44 to carry out instructions. The processor 94 of the network entity may process the request received from the platform-independent application 42 and may generate a message with data instructing the DSA 44 to carry out or execute the instructions. The message generated by the network entity may also include a network or IP address of the network entity and the message may be sent by the network entity to the apparatus 50 and may be stored in a memory (e.g., message inbox such as, for e.g., an SMS message inbox) of the apparatus 50. The network entity may also receive data from the DSA 44 in response to the DSA 44 retrieving the message from the memory and carrying out the instructions.

It should be pointed out that the DSA 44 may be preloaded on the apparatus 50. In an exemplary embodiment, the DSA 44 may periodically poll (e.g., every 10 ms) the memory 46 and/or memory device 76 for messages received from the network entity 48. For instance, the DSA 44 may periodically poll a message inbox (e.g., SMS message inbox) of the memory 46 and/or memory device 76 to process new messages sent to the apparatus 50 by the network entity 48. As pointed out above, the DSA 44 may process the messages intended for the DSA 44 and execute the instructions in the message.

By using the browser 40, a user of apparatus 50 may access a platform-independent application 42 (e.g., web application). When the platform-independent application 42 starts, it may generate a request for the user to input a device address or device identifier (DID) that may be utilized to route messages to the apparatus 50 from the network entity 48. Examples of device identifiers include, but are not limited to, a phone number of the apparatus 50, an email address associated with the apparatus 50, an instant message (IM) user name associated with the apparatus 50 or any other suitable unique identifier associated with the apparatus 50.

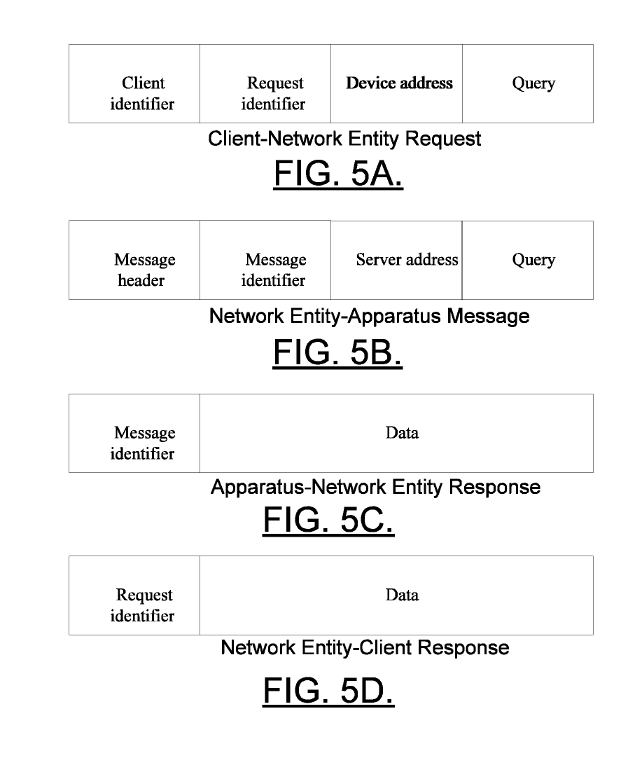

It should be pointed out that when a respective platform-independent application 42 desires to interact with the apparatus 50, for example, to query the positioning sensor 72 for the current location of the apparatus 50, the platform-independent application 42 may generate a request and may send the request to the network entity 48. As shown in FIG. 5A, the request generated by a respective platform-independent application 42 and sent to the network entity 48 may contain the following information: a client identifier (CID), a request identifier (RID), a device address or device identifier (DID) and a query. The query may include information instructing the DSA 44 to carry out or execute instructions and to return the results of the executed instructions to the network entity 48 which may send the results to the respective platform-independent application 42.

The client identifier may uniquely identify the platform-independent application 42 (also referred to herein as client 42) requesting the DSA 44 to carry out or execute instructions. The client identifier may be used by the network entity 48 in asynchronous communication to associate future client 42 requests with saved data in the manner described above. The request identifier may uniquely identify a request sent by a particular client 42. The request identifier may be used by both the application 42 and the network entity to distinguish between multiple requests sent by the same client 42. The device identifier may be used by the network entity 48 to route one or more messages to the apparatus 50. The query generated by client 42 may include data requesting the DSA 44 to carry out or execute instructions.

For purposes of illustration and not of limitation, below are example embodiments of the client requests generated by a client 42. These requests generated by a client 42 may be in the format of the client-network entity message of FIG. 5A.

[CID: Nokia-App-123456789, RID: 1, DID: 1-650-123-4567, Query: “Retrieve GPS”]

[CID: Nokia-App-123456789, RID: 2, DID: 1-650-123-4567, Query: “Read file countries.txt”]

[CID: Nokia-App-123456789, RID: 3, DID: 1-650-123-4567, Query: “Launch Camera”]

The example client requests above indicate that a corresponding client 42 included data in the queries instructing the DSA 44 to retrieve GPS data, read a file, and launch a camera. It should be pointed out that these are examples and that the client requests may include any suitable data requesting the DSA 44 to carry out or execute instructions (e.g., write a file on apparatus 50, launch another application on apparatus 50, monitor an accelerometer on apparatus 50, power down the apparatus 50 for power management, etc.).

When the network entity 48 receives a request from a respective client 42, the network entity may generate a message to be sent to the apparatus 50. In response to receipt of the message from the network entity 48, the apparatus 50 may store the message in memory (e.g., memory 46 and/or memory device 76) and may include the message in a message inbox (e.g., SMS message inbox). The message generated by the network entity may have the format of the network entity-apparatus message of FIG. 5B. In this regard, the message generated by the network entity 48 may include a message header. The message header may include information that indicates that the DSA 44 is the target of the message and the body of the message may comprise text including but not limited to, a message identifier, a network address or IP address and the query provided to the network entity from a respective client 42.

For purposes of illustration and not of limitation, the following messages are example embodiments of the messages generated by the network entity 48.

[Subject: “DSA Request”, Body: [Message ID: Nokia-App-123456789-1, Address: http://server.nokiapaloalto.com, Query: “Retrieve GPS”] ]

[Subject: “DSA Request”, Body: [Message ID: Nokia-App-123456789-2, Address: http://server.nokiapaloalto.com, Query: “Read file countries.txt”] ]

[Subject: “DSA Request”, Body: [Message ID: Nokia-App-123456789-3, Address: http://server.nokiapaloalto.com, Query: “Launch camera”] ]

It should be pointed out that the DSA 44 may analyze the message header of the message generated by the network entity 48 to determine whether the DSA 44 is the intended target for the message. In this exemplary embodiment, based on the identification that the message relates to a DSA Request, the DSA 44 may determine that it is the intended target of the message generated by the network entity 48.

As described above, the DSA 44 may execute the instructions in the message generated by the network entity 48 and may send any relevant data in a response to the network entity 48. The DSA 44 may send the relevant data to the network entity based in part on using the address of the network entity 48 in the message generated by the network entity 48. As shown in FIG. 5C, the format of the response (also referred to herein as an apparatus-network entity response) generated by the DSA 44 which may be sent to the network entity 48 may include a message identifier and the data requested by the network entity 48.

For purposes of illustration and not of limitation, the following are exemplary embodiments of responses that may be generated by the DSA 44 and may be sent by the DSA 44 to the network entity 48.

[Message ID: Nokia-App-123456789-1, Data: “37.481397, −122.185822”].

[Message ID: Nokia-App-123456789-2, Data: “Angola, Bolivia, Chile, Denmark”].

[Message ID: Nokia-App-123456789-3, Data: “[INFO: Camera started]”].

In the exemplary embodiments of the responses generated by the DSA 44 set forth above, the DSA 44 includes the results of the data requested by the network entity 48. For instance, in response to the query “Retrieve GPS”, the DSA 44 may provide longitude and latitude coordinates (e.g., 37.481397, −122.185822) to the network entity 48. In response to a query to read a file from the device, the DSA 44 may provide the data contents of the file and in response to a query to launch the device camera, the DSA 44 may provide data indicating that the camera is started.

It should be pointed out that when the network entity 48 receives a response from the DSA 44, the network entity 48 may utilize the message identifier in the response to determine the appropriate client 42 in which to send the data provided to the network entity by the DSA 44.

As shown in FIG. 5D, the network entity 48 may generate a message (also referred to herein as a network entity-client response) having a request identifier (e.g., “RID: 1”) and the data provided by the DSA 44 to the network entity. The network entity 48 may send this message to the client 42 and the client 42 may use the data in any suitable manner. For example, the respective client 42 may utilize the data provided by the network entity 48 to extend its services, operations, functionalities and/or capabilities.

For purposes of illustration and not of limitation, the following are example embodiments of messages that may be generated by the network entity 48 and may be sent by the network entity 48 to a respective client 42.

[RID: 1, Data: “37.481397, −122.185822”]

[RID: 2, Data: “Angola, Bolivia, Chile, Denmark”]

[RID: 3, Data: “[INFO: Camera started]”]

It should be pointed out that the network entity 48 may send the data received from the DSA 44 to the respective client 42 using a current connection between the apparatus 50 and the network entity 48 when the entire process occurs within a single HTTP connection. On the other hand, if the connection between the apparatus 50 and network entity 48 has expired, the network entity 48 may save and store the data received from the DSA 44. It should be pointed out that the connection may expire for any of the following reasons, including but not limited to: (a) a time period elapsing before the data from the DSA 44 is provided to a respective client 42; (b) there is a network failure such that the connection is closed; and (c) the apparatus 50 is turned off or for any other suitable reasons. When network entity 48 receives another request or message from the same client 42 requesting the DSA 44 to carry out instructions, the network entity 48 may send the saved data to the respective client 42. As described above, the responses sent by the network entity 48 to the client 42 may include an RID. In this regard, the client 42 may use an RID received in a message from the network entity 48 to identify previous requests for data that were sent to the network entity 48. In this regard, the client 42 may determine that the data being received from the network entity 48 relates to previous requests that were sent by the client 42 to the network entity 48.

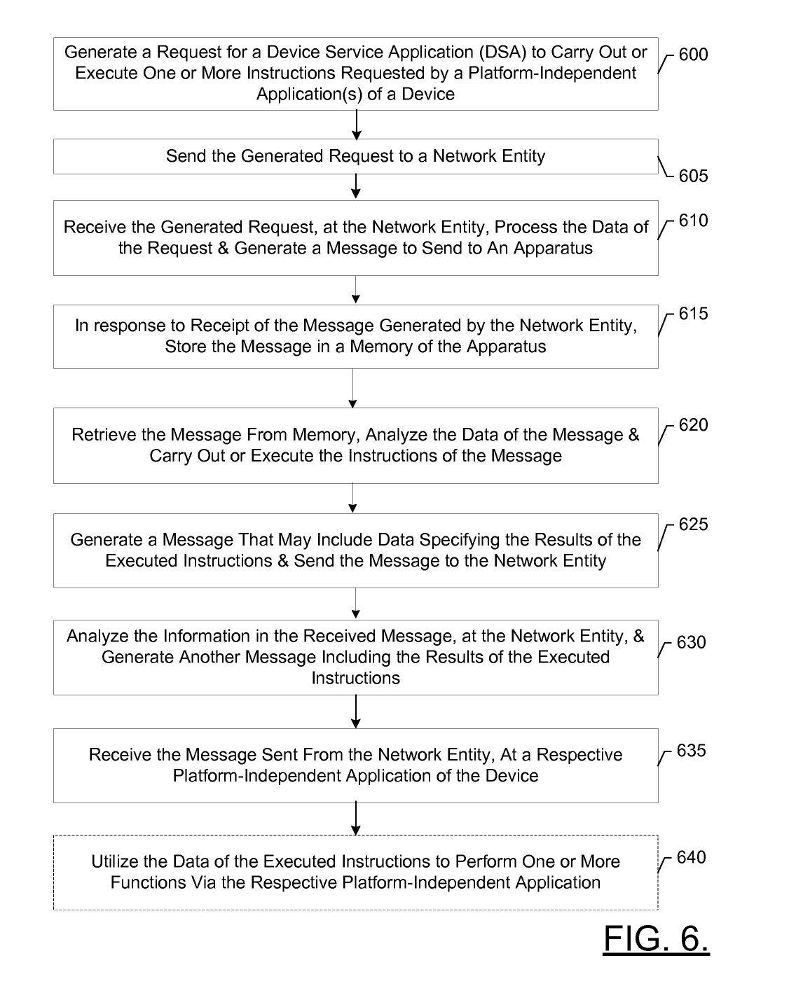

Referring now to FIG. 6, an exemplary embodiment of a flowchart for extending the services, operations, functionalities and/or capabilities of one or more platform-independent applications is provided. At operation 600, at least one platform-independent application 42 (e.g., web application) of a device (e.g., extension module 78) may generate a request for a DSA (e.g., DSA 44) to carry out or execute one or more instructions on an apparatus (e.g., apparatus 50). At operation 605, the request may be sent by the platform-independent application 42 to a network entity (e.g., network entity 48).

At operation 610, the network entity may receive the request from the platform-independent application, process the data of the request and may generate a message to send to the apparatus. The message generated by the network entity may include, but is not limited to, information instructing the DSA to carry out or execute instructions requested by the platform-independent application as well as a network or IP address corresponding to the network entity. The network entity may send the message to the apparatus. At operation 615, in response to receipt of the message, the apparatus may store the message in a memory (e.g., memory 46 or memory device 76). In an exemplary embodiment, the apparatus may store the message in a message inbox (e.g., SMS message inbox, MMS message inbox, or email message inbox) of the memory.

At operation 620, the DSA may retrieve the message from the memory sent from network entity, analyze the data of the message and carry out or execute the instructions of the message. In executing the instructions, the DSA may, but need not, instruct another device (e.g., positioning sensor 72, sensor(s) 71) to perform a function (e.g., obtain location information, obtain tilt information) and may provide the results (e.g., GPS coordinates, tilt information) of the performed function to the DSA.

At operation 625, the DSA may generate a message that may include data specifying the results of the executed instructions. The message generated by the DSA may also include a message identifier that may be used to determine a platform-independent application that requested the information in the message. The DSA may send the generated message to the network entity.

At operation 630, the network entity may analyze the information in the message received from the DSA and based at least in part on the analysis of the information, the network entity may generate another message that includes the results of the executed instructions provided by the DSA. At operation 635, a respective platform-independent application of the device (e.g., extension module 78) may receive the message, which includes the data specifying the results of the executed instructions, from the network entity. Optionally, at operation 640, the respective platform-independent application may utilize the data of the results of the executed instructions to perform one or more functions. In this regard, the respective platform-independent application may extend its services, operations, functionalities and/or capabilities. By receiving relevant data from the DSA, the platform-independent application may extend its functionalities or capabilities without modification of its corresponding software instructions, computer code or the like.

It should be pointed out that FIG. 6 is a flowchart of a system, method and computer program product according to exemplary embodiments of the invention. It will be understood that each block of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 46, memory device 76, memory 96) and executed by a processor (e.g., processor 70, extension module 78, processor 94). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In an exemplary embodiment, an apparatus for performing the method of FIG. 6 above may comprise a processor (e.g., the processor 70, extension module 78, processor 94) configured to perform some or each of the operations (600-640) described above. The processor may, for example, be configured to perform the operations (600-640) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (600-640) may comprise, for example, the processor 70 (e.g., as means for performing any of the operations described above), the extension module 78, the processor 94 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
generating a request via at least one platform-independent application, the request comprises a query including information requesting a platform-dependent device to execute one or more instructions;
directing sending of the request to a network entity;
receiving a message from the network entity comprising data instructing the device to execute the instructions;
executing, via the device, the instructions in response to analyzing the data of the message; and
facilitating provision of one or more results of the executed instructions to the network entity to enable sending of the results to the platform-independent application which uses the results to extend one or more functionalities of the application.

2. The method of claim 1,
wherein executing further comprises instructing another device to perform one or more functions and provide the data associated with the functions to the device, and
wherein the device comprises a native application that is dependent on a particular device platform.

3. The method of claim 1, wherein prior to executing the instructions, the method further comprises retrieving the message from a data repository based on a determination that the message is intended for the device.

4. The method of claim 3, further comprising:
periodically polling the data repository for receipt of messages from the network entity, the messages comprise data instructing the device to execute instructions that are requested by corresponding platform-independent applications.

5. The method of claim 1, wherein the platform-independent application comprises a web application that is executable in part by a web browser, the web application is accessible via a network.

6. The method of claim 1, further comprising receiving content, via the application, the content indicates results of executed instructions generated by the device based on one or more previous requests sent by the application to the network entity.

7. The method of claim 6,
wherein receiving the content occurs in response to a receipt of a subsequent request for executed instructions to be carried out by the device, the subsequent response is generated and provided by the application to the network entity, and
wherein prior to receiving the content, the content associated with the previous requests is stored by the network entity on behalf of the application.

8. The method of claim 3, further comprising analyzing, via the device, a header of the message to determine whether the device is the intended target of the message.

9. The method of claim 2, wherein the device platform comprises an operating system.

10. An apparatus comprising:
at least one processor; and
at least one memory including computer program code, the at least one memory and the computer program code configured to, with the at least one processor cause the apparatus to perform at least the following:
facilitate generation of a request via at least one platform-independent application, the request comprises a query including information requesting a platform-dependent device to execute one or more instructions;
direct sending of the request to a network entity;
receive a message from the network entity comprising data instructing the device to execute the instructions;
facilitate execution of the instructions, via the device, in response to analyzing the data of the message; and
facilitate provision of one or more results of the executed instructions to the network entity to enable sending of the results to the platform-independent application which uses the results to extend one or more functionalities of the application.

11. The apparatus of claim 10, wherein the at least one memory and the computer program code are further configured to, with the at least one processor, cause the apparatus to facilitate execution of the instructions by instructing another device to perform one or more functions and provide the data associated with the functions to the device, and wherein the device comprises a native application that is dependent on a particular device platform.

12. The apparatus of claim 10, wherein the at least one memory and the computer program code are further configured to, with the at least one processor, cause the apparatus to retrieve the message from a data repository based on a determination that the message is intended for the device, prior to execution of the instructions.

13. The apparatus of claim 12, wherein the at least one memory and the computer program code are further configured to, with the at least one processor, cause the apparatus to:
periodically poll the data repository for receipt of messages from the network entity, the messages comprise data instructing the device to execute instructions that are requested by corresponding platform-independent applications.

14. The apparatus of claim 10, wherein the platform-independent application comprises a web application that is executable in part by a web browser, the web application is accessible via a network.

15. The apparatus of claim 10, wherein the at least one memory and the computer program code are further configured to, with the at least one processor, cause the apparatus to facilitate receipt of content, via the application, the content indicates results of executed instructions generated by the device based on one or more previous requests sent by the application to the network entity.

16. The apparatus of claim 15,
wherein receipt of the content occurs in response to a receipt of a subsequent request for executed instructions to be carried out by the device, the subsequent response is generated and provided by the application to the network entity, and
wherein prior to receipt of the content, the content associated with the previous requests is stored by the network entity on behalf of the application.

17. The apparatus of claim 12, wherein the at least one memory and the computer program code are further configured to, with the at least one processor, cause the apparatus to analyze a header of the message to determine whether the device is the intended target of the message.

18. The apparatus of claim 11, wherein the device platform comprises an operating system.

19. A computer program product comprising at least one computer-readable storage medium having computer-readable program code portions stored therein, the computer-readable program code portions comprising:
program code instructions configured to facilitate generation of a request, via at least one platform-independent application, the request comprises a query including information requesting a platform-dependent device to execute one or more instructions;
program code instructions configured to direct sending of the request to a network entity;
program code instructions configured to facilitate receipt of a message from the network entity comprising data instructing the device to execute the instructions;
program code instructions configured to facilitate execution of the instructions, via the device, in response to analyzing the data of the message; and
program code instructions configured to facilitate provision of one or more results of the executed instructions to the network entity to enable sending of the results to the platform-independent application which uses the results to extend one or more functionalities of the application.

20. The computer program product of claim 19,
wherein the execution of the instructions further comprises instructing another device to perform one or more functions and provide the data associated with the functions to the device, and
wherein the device comprises a native application that is dependent on a particular device platform.
